(19) United States
(12) Patent Application Publication
(10) Pub. No.: US 2018/0291962 A1
(43) Pub. Date: Oct. 11, 2018

(54) MODULAR SHAFT

(71) Applicant: Usinage Filiatrault Inc., Palmarolle (CA)

(72) Inventor: Paul Fortin, Palmarolle (CA)

(21) Appl. No.: 15/573,964

(22) PCT Filed: May 13, 2016
(86) PCT No.: PCT/IB2016/052801

§ 371 Date: Nov. 14, 2017

Related U.S. Application Data
(60) Provisional application No. 62/161,647, filed on May 14, 2015.

(51) Int. Cl. F16D 1/04; F16C 3/02

(52) U.S. Cl. CPC F16D 1/04; F16C 2322/50; F16C 3/023

(57) ABSTRACT

A modular shaft including a first body having a first section and a second section extending therefrom, the first section including a first recess extending from the first end, and the second section including a first tongue extending from an end thereof opposite to the first section and the first body also including an alignment key. The modular shaft further includes a second body securable to the first body, the second body having a third section and a fourth section extending therefrom, the third section provided with a second recess for receiving the first tongue therein, and the fourth section including a second tongue extending from an end thereof opposite to the third section for insertion into the first recess of the first section of the first body, and the second body also including an alignment recess for receiving the alignment key.

### TECHNICAL FIELD

The present invention relates to the field of modular shafts for machine tools, and particularly to modular rotary shafts which can be fitted on machine tools for the transmission of torque or precision sliding.

### BACKGROUND

In the field of portable machining using a portable boring machine, shafts of different length are usually used. Therefore, it may be required to have numerous shafts of different length in order to be able to perform different matching processes.

In order to overcome this drawback, modular shafts have been developed. The length of a modular shaft may be varied by varying the number of shaft segments connected together to form the shaft. For example, US Patent Application No. 2014/0119822 teaches a modular shaft which comprises a plurality of shaft segments removably secured together. However, the connections taught in the patent application for connecting together two shaft segments provide a substantially low rigidity to the modular shaft when assembled.

Therefore, there is a need for an improved modular shaft.

### SUMMARY

In accordance with a broad aspect, there is provided a modular shaft comprising: a first longitudinal body extending along a first longitudinal axis and comprising a first section extending between a first end and a second end and a second section extending from the first end of the first section, the first section comprising a first recess extending from the first end, and the second section comprising a first torque transmission tongue extending from an end thereof opposite to the first section and an alignment key protruding from a planar face thereof; and a second longitudinal body extending along a second longitudinal axis and being securable to the first longitudinal body, the second longitudinal body comprising a third section extending between a third end and a fourth end and a fourth section extending from the third end of the third section, the third section end being provided with a second recess for receiving the first torque transmission tongue therein, and the fourth section comprising a second torque transmission tongue extending from an end thereof opposite to the third section for insertion in the first recess of the first section of the first longitudinal body and an alignment recess provided on a planar face thereof for receiving the alignment key.

In one embodiment, the first and third sections each have a cylindrical shape and the second and fourth sections each have a hemi-cylindrical shape.

In one embodiment, the alignment key comprise a protrusion extending radially away from the planar surface of the second section and longitudinally along a portion of the second section, and the alignment recess extends longitudinally along a portion of the fourth section.

In one embodiment, the alignment key is entered along a diameter of the second section and the alignment recess is centered along a diameter of the fourth section.

In one embodiment, a length of the alignment recess is greater than a length of the alignment key.

In one embodiment, the alignment key and the alignment key each have a rectangular shape provided with rounded ends.

In one embodiment, the second section is provided with two first securing holes each extending therethrough and each positioned adjacent to a respective end of the alignment key.

In one embodiment, the fourth section is provided with two second securing holes each extending therethrough and each emerging in the alignment recess adjacent to a respective end thereof.

In one embodiment the fourth section is provided with a first aperture extending therethrough and emerging in the alignment recess, the aperture being located between the two second securing holes.

In one embodiment, the second section is provided with two second apertures each extending through the second section and the alignment key.

In one embodiment, the second end of the first longitudinal body is securable to a machining tool.

In another embodiment, the first longitudinal body further comprises a fifth section extending from the second end thereof and is further provided with a third recess for receiving a further torque transmission tongue therein, the fifth section having a hemi-cylindrical shape and comprising a third torque transmission tongue extending from an end thereof opposite to the first section and a further alignment recess provided on a planar face thereof for receiving a further alignment key.

In one embodiment, the further alignment recess extends longitudinally along a portion of the fifth section.

In one embodiment, the further alignment recess is centered along a diameter of the fifth section.

In one embodiment, the further alignment has a rectangular shape provide with rounded ends.

In one embodiment, the fourth end of the second longitudinal body is securable to a machining tool.

In another embodiment, the second longitudinal body further comprises a fifth section extending from the fourth end thereof and is further provided with a third recess for receiving a further torque transmission tongue therein, the fifth section having a hemi-cylindrical shape and comprising a further alignment key protruding from a planar face thereof.

In one embodiment, the further alignment key extends longitudinally along a portion of the fifth section.

In one embodiment, the further alignment key is centered along a diameter of the fifth section.

In one embodiment, the further alignment key has a rectangular shape provided with rounded ends.

### BRIEF DESCRIPTION OF THE DRAWINGS

Further features and advantages of the present invention will become apparent from the following detailed description, taken in combination with the appended drawings, in which:

FIG. 1 is a top view of a modular shaft comprising a central segment, a first end segment, and a second end segment, in accordance with an embodiment;

FIG. 2 is a side view of the modular shaft of FIG. 1;

FIG. 3 is a cross-sectional side view of the central segment of FIG. 1;

FIG. 4 is a bottom view of the central segment of FIG. 3;

FIG. 5 is a side view of the central segment of FIG. 3;

FIG. 6 is a cross-sectional side view of the first end segment of FIG. 1;

FIG. 7 is a top view of the first end segment of FIG. 6;

FIG. 8 is a side view of the first end segment of FIG. 6;

FIG. 9 is a cross-sectional side view of the second end segment of FIG. 1;

FIG. 10 is a top view of the second end segment of FIG. 9;

FIG. 11 is a side view of the second end segment of FIG. 9;

FIG. 12 illustrates an end segment comprising a dove tail adaptor, in accordance with an embodiment.

FIG. 13 illustrates an end segment comprising a blind bore 90° adaptor, in accordance with an embodiment;

FIG. 14 illustrates an end segment comprising a blind bore 60° adaptor, in accordance with an embodiment;

FIG. 15 illustrates an end segment comprising a morse taper adaptor, in accordance with an embodiment; and

FIG. 16 illustrates an end segment comprising a reducer shaft adaptor, in accordance with an embodiment.

It will be noted that throughout the appended drawings, like features are identified by like reference numerals.

### DETAILED DESCRIPTION

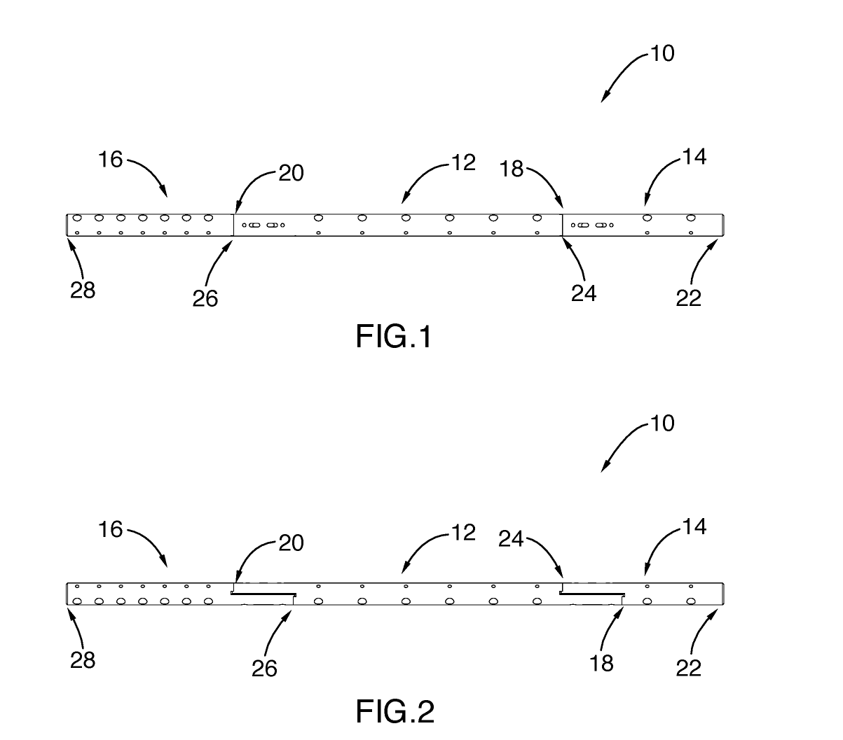

FIGS. 1 and 2 illustrate one embodiment of a modular shaft 10 for a portable machining tool. The illustrated modular shaft 10 comprises three segments 12, 14 and 16, i.e. a central segment 12 and two end segments 14 and 16. The central segment 12 extends along a longitudinal axis between a first end 18 and a second end 20. The end segment 14 is removably secured to the first end 18 of the central segment 12 while the end segment 16 is removably secured to the second end 20 of the central segment 12 to form the modular shaft 10. The end segment 14 extends longitudinally between a first end 22 and a second end 24 which is removably secured to the central segment 12. The first end 22 of the end segment 14 is designed so as to be securable to a machining tool. The end segment 16 also extends longitudinally between a first end 26 which is removably secured to the central segment 12 and a second end 28. In the illustrated embodiment, the modular shaft 10 has a circular cross-sectional shape and the diameter of the modular shaft 10 is substantially constant along a length thereof. However, it should be understood that the configuration of the modular shaft may vary from the one illustrated in FIGS. 1 and 2. For example, the modular shaft may compose sections which may not be cylindrical and the cross-sectional dimensions of the modular shaft may vary along its longitudinal axis.

While the modular shaft 10 comprises three segments 12, 14, 16, it should be understood that the number segments may vary as long as the modular shaft comprises at least two segments removably securable together, of which a given segment is adapted to be secured to a machining tool. The length of the modular shaft 10 may be varied by varying the number of the segments connected together and/or by connecting together segments having different length.

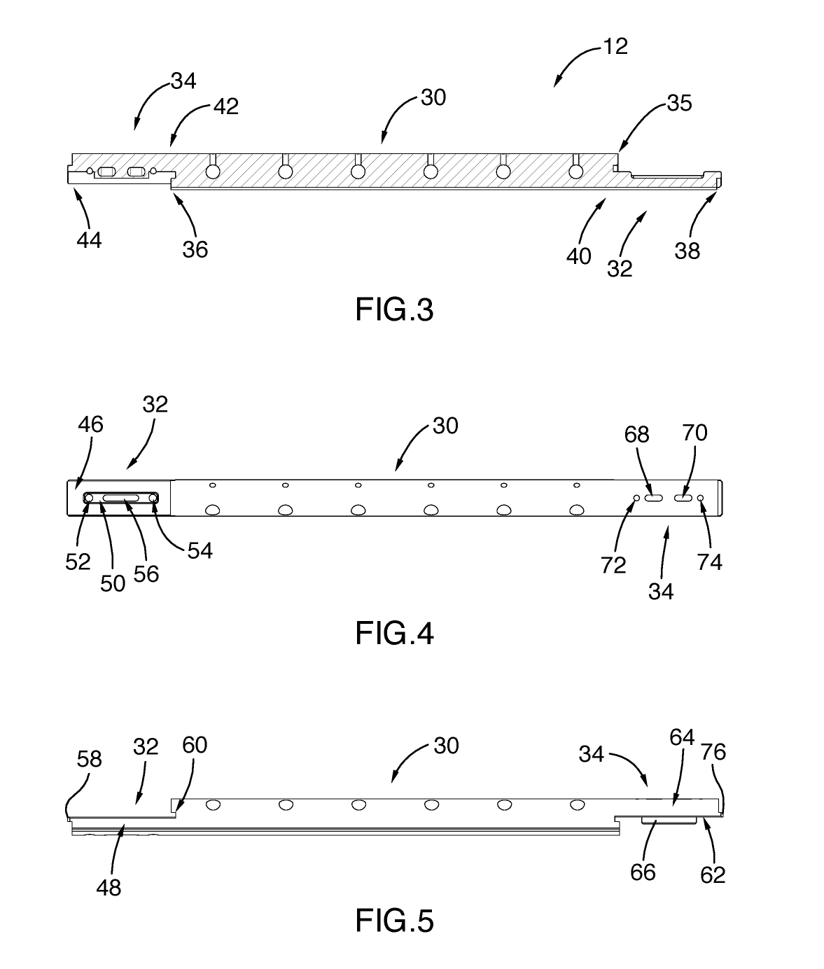

FIGS. 3-5 illustrate an embodiment of a central shaft segment 12 which comprises three sections, i.e. a central cylindrical section 30 and two hemi-cylindrical sections 32 and 34. The hemi-cylindrical section 32 forms a female connector adapted to be removably secured to a corresponding male connector while the hemi-cylindrical section 34 forms a male connector adapted to be removably secured to a corresponding female connector. The central section 30 extends longitudinally between a first end 35 and a second end 36 and has a substantially circular cross-sectional shape between the two ends 35 and 36. The hemi-cylindrical section 32 extends longitudinally between a first end 38 and a second end 40 which projects from the end 35 of the central section 30. Similarly, the hemi-cylindrical section 34 extends longitudinally between a first end 42 which projects from the end 36 of the central section 30 and a second end 44.

The hemi-cylindrical section 32 has a hemi-cylindrical shape and comprises a substantially planar face 46 and an outer hemi-cylindrical face 48. The planar face 46 has a substantially rectangular shape and width of the planar face 46 corresponds to the diameter of the hemi-cylindrical section 32. An alignment recess 50 extends transversally from the planar face 46 toward the hemi-cylindrical face 48 along a portion of the radius of the hemi-cylindrical section 32 and longitudinally along a portion of the length of the hemi-cylindrical section 32. The alignment recess 50 has a substantially rectangular shape having rounded ends and is centered on the central axis of the hemi-cylindrical section 32. Two securing apertures or holes 52 and 54 extend from the hemi-cylindrical face 48 and emerge in the alignment recess 50. The two securing apertures 52 and 54 are each positioned adjacent to a respective rounded end of the alignment recess 50.

The hemi-cylindrical section 32 is further provided with a substantially rectangular aperture 56 which also extends from the hemi-cylindrical face 48 and emerges in the alignment recess 50. The aperture 56 is positioned between the two securing apertures 52 and 54 and extends along a portion of the alignment recess 50. A torque transmission protrusion or tongue 58 also projects from the end 38 of the hemi-cylindrical section 32. The torque transmission protrusion 58 extends along the width of the hemi-cylindrical section 32 and has rounded ends. The torque transmission protrusion 58 is positioned so that its top face and the planar face 46 form a continuous surface. The torque transmission protrusion 58 is adapted to be inserted into a mating torque transmission recess as described below.

The end face 35 of the hemi-cylindrical section 32 is further provided with a torque transmission recess 60 which is adapted to receive therein a mating torque transmission protrusion. The torque transmission recess 60 is positioned so that a wall of the torque transmission recess 60 and the planar face 46 form together a continuous surface.

The hemi-cylindrical section 34 comprises a substantially planar face 62 and an outer hemi-cylindrical face 64. The planar face 62 has a substantially rectangular shape and the width of the planar face 62 corresponds to the diameter of the hemi-cylindrical section 34. An alignment protrusion 66 protrudes from the planar face 64 in a direction orthogonal to the longitudinal axis of the hemi-cylindrical section 34 and extends along a portion of the length of the hemi-cylindrical section 34. The alignment protrusion 66 has a substantially rectangular shape having rounded ends and is centered on the central axis of the hemi-cylindrical section 34. Two substantially rectangular apertures or holes 68 and 70 having rounded ends extend transversally from the hemi-cylindrical face 48 through the hemi-cylindrical section 34 and the alignment protrusion 66. Two securing apertures or holes 72 and 74 each extend from the planar face 62 of the hemi-cylindrical section 34 through at least a portion of the radius of the hemi-cylindrical section 34. In the illustrated embodiment, each one of the two securing apertures 72 and 74 extends through the thickness of the hemi-cylindrical section 34. The two apertures 72 and 74 are each positioned adjacent to a respective rounded end of the alignment protrusion 66.

A torque transmission protrusion or tongue 76 also extends from the end face 44 of the hemi-cylindrical section 34. The torque transmission protrusion 76 extends along the width of the hemi-cylindrical section 34 and has rounded ends. The torque transmission protrusion 76 is positioned so that one of its faces and the planar face 62 form a continuous surface. The torque transmission protrusion 76 is adapted to be inserted into a mating torque transmission recess as described below.

The end face 36 of the central section 30 is further provided with a torque transmission recess 78 which is adapted to receive therein a mating torque transmission protrusion. The torque transmission recess 78 is positioned so that a wall of the torque transmission recess 78 and the planar face 62 form together a continuous surface.

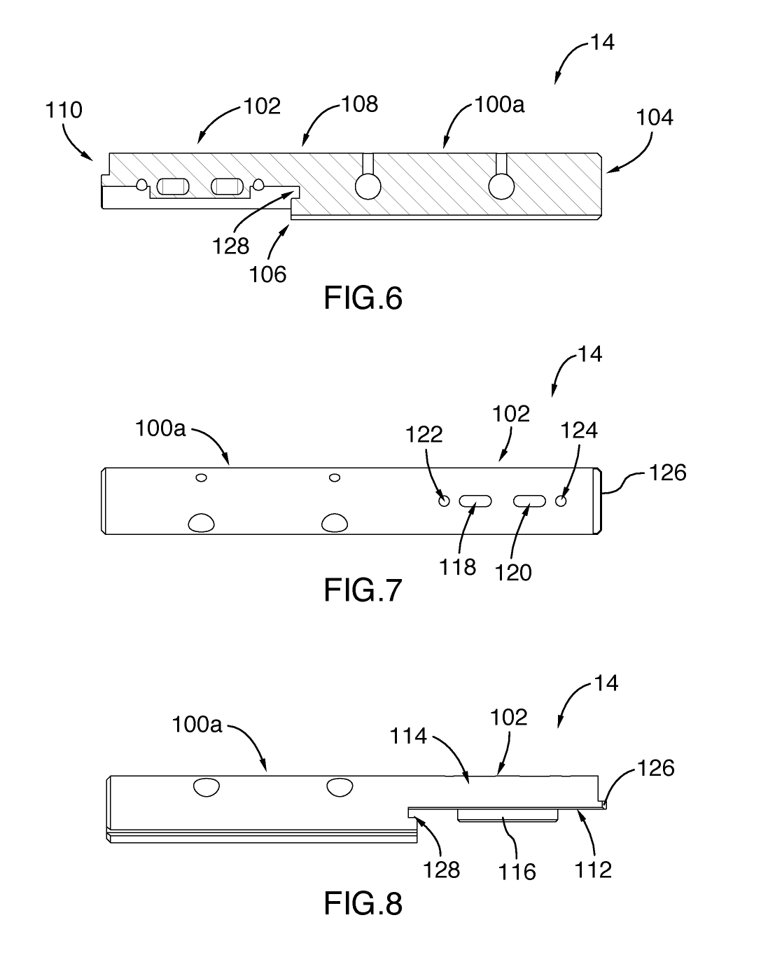

FIGS. 6-8 illustrate a first embodiment of an end segment 14. The end section 14 comprises a cylindrical section 100a and a hemi-cylindrical section 102. The hemi-cylindrical section 102 form a male connector adapted to be removably secured to the female connector 32 of the central segment 12.

The cylindrical section 100a has a circular cross-section and extends longitudinally between a first end 104 and a second end 106. The end 104 is sized and shaped so as to be secured to a machining tool. The hemi-cylindrical section 102 extends longitudinally between a first end 108 which is secured to the end 106 of the cylindrical section 100a and a second end 110, and comprises a substantially planar face 112 and an outer hemi-cylindrical face 114. The planar face 112 has a substantially rectangular shape and the width of the planar face 112 corresponds to the diameter of the hemi-cylindrical section 102. An alignment protrusion 116 protrudes from the planar face 112 in a direction orthogonal to the longitudinal axis of the hemi-cylindrical section 102 and extends along a portion of the length of the hemi-cylindrical section 102. The alignment protrusion 116 has a substantially rectangular shape having rounded ends and is centered on the central axis of the hemi-cylindrical section 102. The shape and size of the alignment protrusion 116 are chosen so that the alignment protrusion be inserted into the alignment recess 50 of the central segment 12.

Two substantially rectangular apertures or holes 118 and 120 having rounded ends extend transversally from the hemi-cylindrical face 114 through the hemi-cylindrical section 102 and the alignment protrusion 116. Two securing apertures or holes 122 and 124 each extend from the planar face 112 of the hemi-cylindrical section 102 through at least a portion of the radius of the hemi-cylindrical section 102. In the illustrated embodiment, each one of the two securing apertures 122 and 124 extends through the entire thickness of the hemi-cylindrical section 102. The two apertures 122 and 124 are each positioned adjacent to a respective rounded end of the alignment protrusion 116.

A torque transmission protrusion or tongue 126 also extends from the end face 110 of the hemi-cylindrical section 102. The torque transmission protrusion 126 extends along the width of the hemi-cylindrical section 102 and has rounded ends. The torque transmission protrusion 126 is positioned so that one of its faces and the planar face 112 form a continuous surface. The torque transmission protrusion 126 is shaped and sized to be inserted into the torque transmission recess 60 of the central segment 12.

The end face 106 of the cylindrical section 100a is further provided with a torque transmission recess 128 which is adapted to receive therein the torque transmission protrusion 58 of the central segment 12. The torque transmission recess 78 is positioned so that a wall of the torque transmission recess 78 and the planar face 62 form together a continuous surface.

It should he understood that the shape and size of the alignment protrusion 116 and its position relative to the planar face 112 as well as the shape and size of the alignment recess 50 and its position relative to the planar face 46 are chosen so as to allow the insertion of the alignment protrusion 116 into the alignment recess 50 when the segment 14 is removably secured to central segment 12. The width of the alignment protrusion 116 is substantially equal to the width of the alignment recess 50 so that substantially no transverse relative movement be possible between the alignment recess and protrusion 50 and 116 when the alignment protrusion 116 is inserted into the alignment recess 50. As a result, the alignment protrusion 116 may be seen as an alignment key which allows aligning transversally the hemi-cylindrical sections 32 and 102 together so that the hemi-cylindrical faces 48 and 114 form a continuous cylindrical surface when the segments 12 and 14 are connected together.

The length of the alignment protrusion 116 is less than that of the alignment recess 50 to provide a mechanical play which allows the insertion of the torque transmission protrusion 126 into the torque transmission recess 60 and the insertion of the torque transmission protrusion 58 into the torque transmission recess 128.

It should be understood that the size and shape of the torque transmission protrusion 126 and its position relative to the end face 110 as well as the size and shape of the torque transmission recess 60 and its position relative to the end face 40 are chosen so as to allow the insertion of the torque transmission protrusion 126 into the torque transmission recess 60 when the segment 14 is removably secured to central segment 12. Similarly, the size and shape of the torque transmission recess 128 and its position relative to the end face 106 as well as the size and shape of the torque transmission protrusion 58 and its position relative to the end face 38 are chosen so as to allow the insertion of the torque transmission protrusion 158 into the torque transmission recess 128 when the segment 14 is removably secured to central segment 12.

When the segments 12 and 14 are assembled together and upon rotation of the central segment 12 about its longitudinal axis, the assembly formed of the torque transmission protrusion 126 and the torque transmission recess 60 and the assembly formed of the torque transmission protrusion 58 and the torque transmission recess 128 allow the transmission of the rotation of the central segment 12 to the end segment 14.

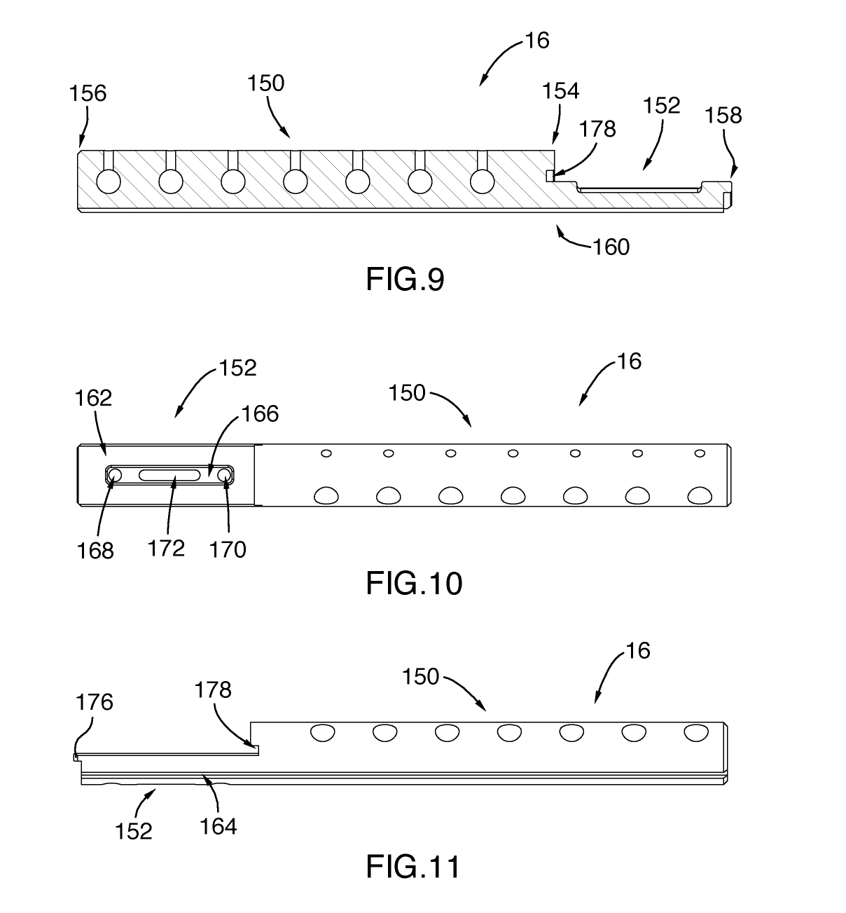

FIGS. 9-11 illustrate one embodiment of an end segment 16. The end section 16 comprises a cylindrical section 150 and a hemi-cylindrical section 152. The hemi-cylindrical section 152 form a female connector adapted to be removably secured to the male connector 34 of the central segment 12.

The cylindrical section 150 has a circular cross-section and extends longitudinally between a first end 154 and a second end. The hemi-cylindrical section 152 extends longitudinally between a first end 158 and a second end 160 which is secured to the end 154 of the cylindrical section 150, comprises a substantially planar face 162 and an outer hemi-cylindrical face 164. The planar face 162 has a substantially rectangular shape and the width of the planar face 162 corresponds to the diameter of the hemi-cylindrical section 152.

An alignment recess 166 extends transversally from the planar face 162 toward the hemi-cylindrical face 164 along a portion of the radius of the hemi-cylindrical section 152 and longitudinally along a portion of the length of the hemi-cylindrical section 152. The alignment recess 166 has a substantially rectangular shape having rounded ends and is centered on the central axis of the hemi-cylindrical section 152. The alignment recess 166 is adapted to receive therein the alignment protrusion 66 of the central segment 12 when the shaft segments 12 and 16 are removably secured together. Two securing apertures or the shaft segments 12 and 16 are removably secured together. Two securing apertures or holes 168 and 170 extend from the hemi-cylindrical face 164 and emerge in the alignment recess 166. The two securing apertures 168 and 170 are each positioned adjacent to a respective rounded end of the alignment recess 166. The hemi-cylindrical section 152 is further provided with a substantially rectangular aperture 172 which also extends from the hemi-cylindrical face 164 and emerges in the alignment recess 166. The aperture 172 is positioned between the two securing apertures 168 and 170.

A torque transmission protrusion or tongue 176 also extends from the end face 158 of the hemi-cylindrical section 152. The torque transmission protrusion 176 extends along the width of the hemi-cylindrical section 152 and has rounded ends. The torque transmission protrusion 176 is positioned so that one of its faces and the planar face 162 form a continuous surface. The torque transmission protrusion 176 is shaped and sized to be inserted into the torque transmission recess 78 of the central segment 12.

The end face 154 of the cylindrical section 150 is further provided with a torque transmission recess 178 which is adapted to receive therein the torque transmission protrusion 76 of the central segment 12. The torque transmission recess 178 is positioned so that a wall of the torque transmission recess 178 and the planar face 162 form together a continuous surface.

It should be understood that the shape and size of the alignment protrusion 66 and its position relative to the planar face 62 as well as the shape and size of the alignment recess 166 and its position relative to the planar face 162 are chosen so as to allow the insertion of the alignment protrusion 66 into the alignment recess 166 when the segment 16 is removably secured to central segment 12. The width of the alignment protrusion 66 is substantially equal to the width of the alignment recess 166 so that substantially no transverse relative movement be possible between the alignment recess and protrusion 166 and 66 when the alignment protrusion 66 is inserted into the alignment recess 166. As a result, the alignment protrusion 66 may be seen as an alignment key which allows aligning transversally the hemi-cylindrical sections 34 and 152 together so that the hemi-cylindrical faces 64 and 164 form a continuous cylindrical surface when the segments 12 and 16 are connected together.

The length of the alignment protrusion 66 is less than that of the alignment recess 166 to provide a mechanical play which allows the insertion of the torque transmission protrusion 176 into the torque transmission recess 78 and the insertion of the torque transmission protrusion 76 into the torque transmission recess 178.

It should be understood that the size and shape of the torque transmission protrusion 176 and its position relative to the end face 158 as well as the size and shape of the torque transmission recess 78 and its position relative to the end face 42 are chosen so as to allow the insertion of the torque transmission protrusion 176 into the torque transmission recess 78 when the segment 16 is removably secured to central segment 12. Similarly, the size and shape of the torque transmission recess 178 and its position relative to the end face 154 as well as the size and shape of the torque transmission protrusion 76 and its positon relative to the end face 44 are chosen so as to allow the insertion of the torque transmission protrusion 76 into the torque transmission recess 178 when the segment 16 is removably secured to central segment 12.

When the segments 12 and 16 are assembled together and upon rotation of the shaft segment 16 about its longitudinal axis, the assembly formed of the torque transmission protrusion 176 and the torque transmission recess 78 and the assembly formed of the torque transmission protrusion 76 and the torque transmission recess 178 allow the transmission of the rotation of the shaft segment 16 to the central segment 12.

In one embodiment, the cylindrical sections 30, 100a, and 150 are provided with holes or apertures regularly spaced apart along the longitudinal axis thereof for securing the modular shaft to a boring machine.

In order to assemble the shaft 10, the end shaft segment 14 may first be secured to the central segment 12. To do so, the torque transmission protrusion 126 of the segment 14 is inserted into the torque transmission recess 60 of the central segment 12, and the alignment protrusion 116 of the segment 14 is inserted into the alignment recess 50 of the segment 12. When the end face 42 of cylindrical section 30 of the segment 12 abuts against the end face 106 of the cylindrical section 100a of the segment 14, the torque transmission protrusion 58 is away from the torque transmission recess 128 thanks to a backlash. The segment 14 is then slid relative to the segment 12 so that the alignment protrusion 116 slides longitudinally into the alignment recess 50 and the torque transmission protrusion 58 penetrates into the torque transmission recess 128. The sliding movement is stopped when the securing holes 52 and 54 face the securing holes 124 and 122, respectively. A screw or bolt is then screwed into the aperture formed of the securing holes 52 and 122 and a further screw or bolt is screwed into the aperture formed of the securing holes 54 and 124. The end segment 14 is then removably secured to the central segment 12.

Then the end segment 16 is secured to the central segment 12. The torque transmission protrusion 176 of the segment 16 is inserted into the torque transmission recess 78 of the central segment 12, and the alignment protrusion 66 of the segment 12 is inserted into the alignment recess 166 of the segment 16. When the end face 154 of cylindrical section 150 of the segment 16 abuts against the end face 36 of the cylindrical section 30 of the segment 12, the torque transmission protrusion 76 is away from the torque transmission recess 178 thanks to a backlash or mechanical float. The segment 16 is then slid relative to the segment 12 so that alignment protrusion 66 slides longitudinally into the alignment recess 166 and the torque transmission protrusion 76 penetrates into the torque transmission recess 178. The sliding movement is stopped when the securing holes 72 and 74 face the securing holes 170 and 168, respectively. A screw or bolt is then screwed into the aperture formed by the securing holes 74 and 170 and a further screw or bolt is screwed into the aperture formed of the securing holes 72 and 168. The end segment 16 is then removably secured to the central segment 12.

In order to disassemble the modular shaft 10 such as in order to disconnect the shaft segments 12 and 14, the screws or bolts are first removed and then a drill drift may be used. The drill drift is inserted through the aperture 48 and the aperture 118 or 120 until it abuts against the segment 14 and the drill shift is pushed to disconnect the segment 14 from the segment 12.

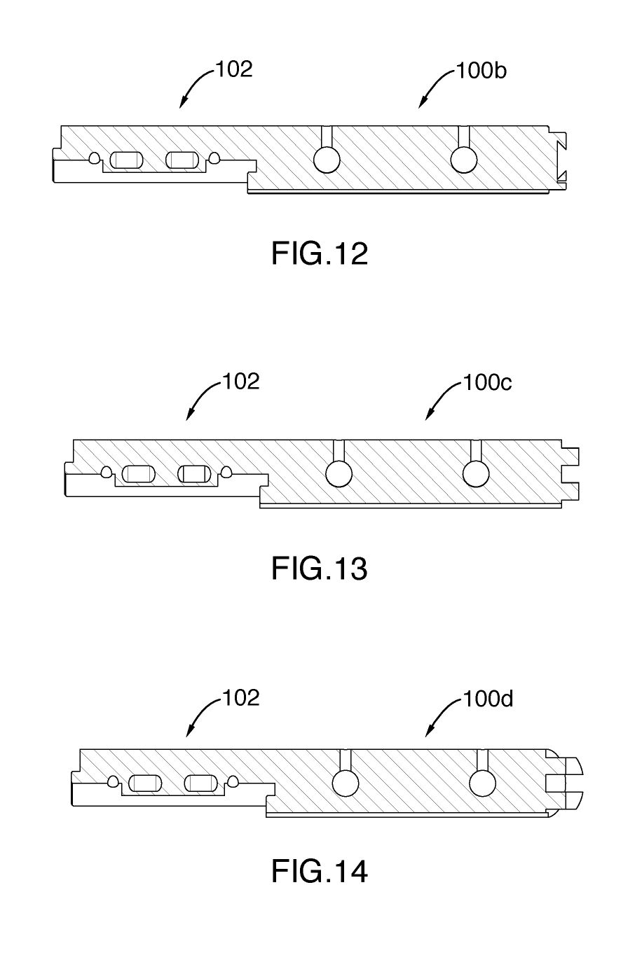

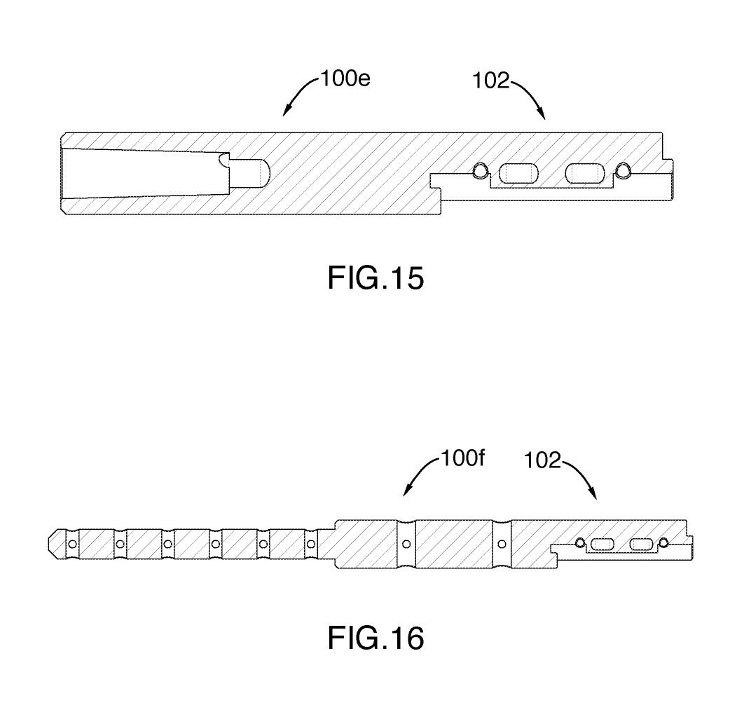

FIGS. 12-16 each illustrate a respective end segment 14 which comprises a cylindrical section 100b-100f, respectively, and a hemi-cylindrical section 102 forming a male connector. Each cylindrical section 100b-100f is adapted to be secured to a respective tool. The cylindrical section 100b illustrated in FIG. 12 corresponds to a dove tall adaptor. The cylindrical section 100c illustrated in FIG. 13 corresponds to a blind bore 90° adaptor. The cylindrical section 100d illustrated in FIG. 14 corresponds to a blind bore 60° adaptor. The cylindrical section 100e illustrated in FIG. 15 corresponds to a morse taper adaptor. The cylindrical section 100f illustrated in FIG. 16 corresponds to a reducer shaft adaptor. It should be understood that the adaptors illustrated in FIGS. 12-16 are exemplary only and the end segment 14 may be provided with any adequate type of adaptor.

In one embodiment, the above-described modular shaft allows an operator performing different machining tasks while only replacing the end shaft segment 14.

The length of the modular shaft may be varied by securing together an adequate number of segments each having an adequate length.

In one embodiment, the above-described modular shaft allows reducing the quantity of raw material required to make a shaft, the machining time, and/or the cost related to the shipment of a shaft. For example, a piece of raw material having a length of 18′ is usually required to make a first shaft of about 4′, a second shaft of about 6′, and a third shaft of about 8′. In comparison, a piece of raw material of about 10′ is required to make a modular shaft comprising a first shaft segment of about 4′, a second shaft segment of about 4′, and a third shaft segment of about 2′. The shaft segments may be combined to provide a shaft having a varying length. For example, by combining a shaft segment having a 4′ length with a shaft segment of 2′, a shaft of about 6′ can be obtained. A shaft of about 8′ length can be obtained by combining two shaft segments of 8′.

While in the illustrated embodiment the modular shaft 10 has a cylindrical shape, the person skilled in the art will understand that the modular shaft may be provided with a shape other than a cylindrical shape. For example, at least a section of the modular shaft may have an oval cross-sectional shape, a rectangular cross-sectional shape, etc.

The embodiments of the invention described above are intended to be exemplary only. The scope of the invention is therefore intended to be limited solely by the scope of the appended claims.

1. A modular shaft, comprising:
a first longitudinal body extending along a first longitudinal axis and comprising a first section extending between a first end and a second end and a second section extending from the first end of the first section, the first section comprising a first recess extending from the first end, and the second section comprising a first torque transmission tongue extending from an end thereof opposite to the first section and an alignment key protruding from a planar face thereof; and
a second longitudinal body extending along a second longitudinal axis and being securable to the first longitudinal body, the second longitudinal body comprising a third section extending between a third end and a fourth end and a fourth section extending from the third end of the third section, the third section end being provided with a second recess for receiving the first torque transmission tongue therein, and the fourth section comprising a second torque transmission tongue extending from an end thereof opposite to the third section for insertion in the first recess of the first section of the first longitudinal body and an alignment recess provided on a planar face thereof for receiving the alignment key, wherein the alignment recess and the alignment key are each provided with a substantially rectangular shape.

2. The modular shaft of claim 1, wherein the first and third sections each have a cylindrical shape and the second and fourth sections each have a hemi-cylindrical shape.

3. The modular shaft of claim 2, wherein the alignment key comprises a protrusion extending radially away from the planar surface of the second section and longitudinally along a portion of the second section, and the alignment recess extends longitudinally along a portion of the fourth section.

4. The modular shaft of claim 3, wherein the alignment key is centered along a diameter of the second section and the alignment recess is centered along a diameter of the fourth section.

5. The modular shaft of claim 3, wherein a length of the alignment recess is greater than a length of the alignment key.

6. The modular shaft of claim 1, wherein the alignment key and the alignment recess are each provided with rounded ends.

7. The modular shaft of claim 3, wherein the second section is provided with two first securing holes each extending therethrough.

8. The modular shaft of claim 7, wherein the fourth section is provided with two second securing holes each extending therethrough and each emerging in the alignment recess adjacent to a respective end thereof.

9. The modular shaft of claim 8, wherein the fourth section is provided with a first aperture extending therethrough and emerging in the alignment recess, the aperture being located between the two second securing holes.

10. The modular shaft of claim 9, wherein the second section is provided with two second apertures each extending through the second section and the alignment key.

11. The modular shaft of claim 1, wherein the second end of the first longitudinal body is securable to a machining tool.

12. The modular shaft of claim 2, wherein the first longitudinal body further comprises a fifth section extending from the second end thereof and is further provided with a third recess for receiving a further torque transmission tongue therein, the fifth section having a hemi-cylindrical shape and comprising a third torque transmission tongue extending from an end thereof opposite to the first section and a further alignment recess provided on a planar face thereof for receiving a further alignment key.

13. The modular shaft of claim 12, wherein the further alignment recess extends longitudinally along a portion of the fifth section.

14. The modular shaft of claim 13, wherein the further alignment recess is centered along a diameter of the fifth section.

15. The modular shaft of claim 13, wherein the further alignment recess has a rectangular shape provided with rounded ends.

16. The modular shaft of claim 1, wherein the fourth end of the second longitudinal body is securable to a machining tool.

17. The modular shaft of claim 1, wherein the second longitudinal body further comprises a fifth section extending from the fourth end thereof and is further provided with a third recess for receiving a further torque transmission tongue therein, the fifth section having a hemi-cylindrical shape and comprising a further alignment key protruding from a planar face thereof.

18. The modular shaft of claim 17, wherein the further alignment key extends longitudinally along a portion of the fifth section.

19. The modular shaft of claim 18, wherein the further alignment key is centered along a diameter of the fifth section.

20. The modular shaft of claim 18, wherein the further alignment key has a rectangular shape provided with rounded ends.

21. The modular shaft of claim 7, wherein the two first securing holes are each positioned adjacent to a respective end of the alignment key.
